(19) United States
(12) Patent Application Publication
(10) Pub. No.: US 2008/0200847 A1
(43) Pub. Date: Aug. 21, 2008

(54) Therapeutic Device and Method for Treating and Preventing Spinal Osteoporosis

(76) Inventor: Joseph Bernstein, Haverford, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/677,082

(22) Filed: Feb. 21, 2007

(51) Int. Cl. A61H 1/00

(52) U.S. Cl. 601/33; 601/49

(57) ABSTRACT

A therapeutic device and method for treating and preventing spinal osteoporosis which includes: a means for supporting a sitting patient; a platform connected to the support means upon which the patient may sit; a means for generating vibrations for vibrating the platform, whereby the vibrations are transmitted from the platform to the patient's axial skeleton. The method includes generating vibrations for vibrating a platform upon which a patient sits and transmitting the vibrations to the axial skeleton of the patient in order to move the axial skeleton along a predetermined path.

### BACKGROUND OF THE INVENTION

This invention relates to a means for therapeutically treating and preventing spinal osteoporosis, and more particularly, to an apparatus and method for providing vibratory stimulation to bones in a patient's axial skeleton, while simultaneously shielding the appendicular skeleton, in the context of a cardiovascular exercise regimen.

It is well-established in the medical field that bone forms in response to mechanical stress. This phenomenon is known as Wolff's law in honor of the German anatomist/surgeon Julius Wolff (1835-1902). If the load on a particular bone increases, the bone will remodel itself over time, and will become stronger to resist that sort of loading. The converse is true as well. If the loading on a bone decreases, the bone will become weaker. It follows that bones which are stimulated grow thick and robust. For example, the racquet-holding arm bones of tennis players become much stronger than those of the other arm. By the same token, patients held immobilized in casts for prolonged periods suffer from “disuse osteopenia” caused by demineralization of the skeleton from a lack of stimulation; just as astronauts who spend a long time in space will often return to earth with weaker bones, given that gravity hasn't been exerting a load on their bones.

It is well known that exercise cycles help tone muscles and invigorate the cardiovascular system. Exercise cycles also provide individuals with smooth, low impact workouts and, as a result, are ideal for people who have joint aches and pains. Cycling on a stationary machine is also relatively convenient, does not demand a tremendous amount of skill, and is particularly well-suited for patients with knee or hip arthritis, precisely because cycling does not significantly impact the patient's body. Exercise machines are also an alternative for those people who lack the skill, coordination or stamina for swimming or other low impact exercises. Exercise cycles do not, however, stimulate bone formation; and as such, are not an apt exercise mode for preventing or treating osteoporosis.

There are several known devices and methods for treating various forms of osteoporosis. For example, U.S. Pat. No. 4,570,927 (Petrofsky et al.) describes a therapeutic device for reversing osteoporosis in human limbs which comprises a crank assembly attached to a person's feet. The device includes a motor assembly for rotating the crank assembly so that the limbs move along a predetermined path while a vibrator transmits an impact load to the limbs.

Another anti-osteoporosis device and method is described in U.S. Pat. Nos. 4,858,598 (Halpern) and U.S. Pat. No. 4,858,599 (Halpern). These patents are directed to the prevention and alleviation of a condition of osteoporosis which includes placing a patient on a platform in a standing position and repeatedly raising and lowering the platform thereby imparting a force to the bones of the patient.

U.S. Pat. No. 5,046,484 (Bassett et al.) describes a method and device for treating bone disorders characterized by low bone mass. The device comprises a pivoting platform, a lift lever linked to the platform, a cam follower, a cam and a motor coupled to the cam. The method of the invention involves repeatedly lifting a patent's heels and then allowing them to drop in order to impart an impact load.

More recently, U.S. Pat. No. 6,620,117 (Johnson et al.) describes a similar apparatus as disclosed in the Halpern patents. More specifically, it is directed to a mechanical vibration device for stimulating tissue and organs, including bone tissue. The device includes a base frame, a rigid plate for supporting a human being and a vibrational device such that the plate oscillates in both vertical and horizontal directions. As described in the “Description of Related Art” section of the patent, there are several other patents which are directed to encouraging bone growth with vibration and impact devices.

All of the disclosures set forth in the patents referred to above are incorporated herein by reference. A common feature of all of the prior art inventions for treating osteoporosis and other similar bone diseases is the use of an impact load, primarily on the limbs of a human being, in order to treat the bone disorders or disease. However, while it is known that impact exercise, such as walking, running, etc., can reduce osteoporosis, many patients with or at risk for spinal osteoporosis cannot participate in such exercises because they suffer from joint disorders or disease in, for example, their knees and hips.

No one has been able to address the problems associated with impact exercise as a means of providing therapeutic effects to patients with or at risk of obtaining spinal osteoporosis. Accordingly, there is a need for a therapeutic device which applies an impact load to the spine of a patient in a manner that will not impart the load on other parts of the body suffering from or susceptible to joint disease, such as osteoarthritis. Such a device should be designed to vibrate the bones of the patient's axial skeleton in a number of planes so that many of the bone surfaces are vibrated sufficiently to reverse the effects of spinal osteoporosis, mimicking the load applied to the spine while walking or jogging, for example. In addition, the device should include a means for detecting the resultant vibration of the bones of the subject's spine so that the magnitude of the vibrations actually felt by the bones can be controlled. Thus, there is a further need for a method for effectively using the novel therapeutic device for treating and preventing spinal osteoporosis.

### BRIEF SUMMARY OF THE INVENTION

The invention disclosed and claimed herein addresses the needs presented above. It is therefore an object of the present invention to provide a therapeutic device that combines minimal impact to the lower extremities during exercise all the while providing sufficient impact conditioning to a patient's axial skeleton. In accordance with one aspect of this invention, the device is an exercise cycle that couples pedaling motion with a vibration or bounce to a platform (e.g., seat) upon which a patient sits, such that the spine sustains an impact load.

It is another object of the present invention to provide a vibrational conditioning and/or therapeutic therapy device for those suffering from or at risk of spinal osteoporosis.

Yet another object of the invention is to provide a method for effectively treating spinal osteoporosis.

It is still another object of the invention to provide a method for effectively preventing spinal osteoporosis.

It is an additional object of the present invention, in accordance with one aspect thereof, to make a device available that provides vibrations in a number of planes along a patient's spine.

It is yet another object of the present invention, in accordance with one aspect thereof, to make a device available that mimics the load applied to a patient's spine while walking or jogging.

Still another object of the invention is to provide a therapeutic device which vibrates a patient's spine that is compact, portable, and relatively inexpensive to manufacture thereby making it available to patients on a wide scale.

It is an additional object of this invention, in accordance with one aspect thereof, to provide such a device for home use that is easy to operate.

Additional objects and advantages of the invention will be set forth in the description and embodiments which follow and in part will be apparent from the description, or may be learned by the practice of the invention without undue experimentation.

### DETAILED DESCRIPTION OF THE INVENTION

This invention relates to a means for therapeutically treating and preventing spinal osteoporosis, and more particularly, to an apparatus and method for providing vibratory stimulation to bones in a patient's axial skeleton, while simultaneously shielding the appendicular skeleton, in the context of a cardiovascular exercise regimen.

Impact loading to the axial skeleton of a patient will stimulate bone formation in the spine, help prevent spine deformation, and possibly painful vertebral compression fractures that are caused by osteoporosis. The present invention is a therapeutic device which applies an impact load to the spine of a patient in a manner that will not impart the load on other parts of the body suffering from or susceptible to joint disease, such as osteoarthritis. The device is capable of vibrating the bones of the patient's axial skeleton in a number of planes so that many of the bone surfaces are vibrated sufficiently to reverse the effects of spinal osteoporosis. In one embodiment of the invention, the device includes a means for detecting the resultant vibration of the bones of the patient's spine so that the magnitude of the vibrations actually felt by the bones can be monitored and/or controlled. In a preferred embodiment of the invention, the device mimics the load applied to the spine while walking or jogging.

The present invention is a therapeutic device for treating and preventing spinal osteoporosis which comprises a means for supporting a sitting patient, a platform connected to the support means upon which the patient may sit, and a means for generating vibrations for vibrating the platform. The vibrations are transmitted from the platform to the patient's axial skeleton such that the patient's spine sustains an impact load. Because the impact delivered by the present invention is sent via a platform, as opposed to a patient's limbs, the present invention will not affect the patient's limbs, including the knees and hips, in a manner that will cause or aggravate joint disorders or disease, such as osteoarthritis.

In one embodiment of the present invention, the support means of the therapeutic device comprises a means for moving at least one limb of a patient repeatedly along a cyclical path. Preferably, the moving means includes at least one wheel which is connected to pedals. Thus, in this embodiment, the present invention can be a modification to a stationery exercise bicycle whereby the bicycle seat vibrates thereby transmitting an impact load to the axial skeleton of a patient. The modification allows retention of all of the cycle's benefits, including muscle and cardiovascular toning, but also adds an element of impact loading to the axial skeleton of a patient's body.

The support means and platform can be any objects which will support the weight of a sitting patient. For example, the support means can resemble a bicycle frame and the platform can be, but is not limited to, a seat or a chair. The support means and platform can also be one or multiple parts and can be of various materials of construction. Preferably, the supporting means further includes, but is not limited to, a means for cycling rotatably connected on, for example, the frame and a means for supporting at least one limb of the patient which is in contact with the cycling means. It is expected that the device will typically support two limbs of a patient, although a patient which has only one limb could effectively use the device by, for example, having their limb strapped to the actuating means which, in turn, is connected to the cycling means.

The generating means can be any means which generates vibrations capable of being felt by the axial skeleton of the patient operating the inventive device. For example, as described in the '927 patent of Petrofsky et al., the generating means can be, but is not limited to, an electromagnetic-coupled vibrator that requires an input on the order of about 12 volts to operate.

The therapeutic device of the present invention can be mechanical, electrical or mechanical-electrical. As a result, in one embodiment of the invention, the means for actuating the cycling means is a patient's limb or limbs which mechanically operate at least one pedal connected, directly or indirectly, to a the cycling means to move the limb(s) of the patient repeatedly along a cyclical path. The pedaling action caused by the patient's limb(s) can, in turn, operate a mechanical coupler that propels an impact load in the form of vibrations or bounces to the platform that are ultimately transmitted to the patient's spine. Thus, the cycle is actuated thereby rotating an assembly simulating the riding of a bicycle while approximately simultaneously causing the platform to travel in primarily a vertical path thereby delivering an impact load to the patient's spine.

In another embodiment of the invention, the platform is de-coupled from the cycling means and instead is in communication, either directly or indirectly, with a motor assembly which provides vibrations to the platform such that an impact load is transmitted to the patient's spine independent of the patient's limb(s) moving repeatedly along a cyclical path.

A person of ordinary skill in the art would appreciate that one could also make a hybrid device which contains both mechanical and electrical components. For example, the present invention can be such that the cycling means turns on a switch that governs an electric motor assembly. As a result of this mechanical-electrical action, a patient's spine is only loaded when the patient pedals the cycle, although the actual force is motor-driven. Alternatively, an electric motor can be used, if desired, to operate the cycling means of the device which, in turn, mechanically delivers an impact load in the form of vibrations to the platform.

In another embodiment of the invention, the therapeutic device further includes a programmable computer such that various types and/or amounts of impact loading can be selected by a therapist, doctor or patient. For example, the therapist, doctor or patient could select a relatively small or minimal impact load or, alternatively, a larger impact load depending on the desired amount of impact to be delivered to the patient's spine. A skilled artisan will also envision a therapeutic device where the computer has in its memory simulated terrains and the like such that the impact load resembles the type of loading a patient would receive if the patient was, for example, riding a bicycle on a gravel road.

In another embodiment of the invention, the therapeutic device further includes a means for sensing the vibrations felt by the axial skeleton of the patient. The sensing means is not intended to be limited to any type of sensor but instead can be any sensor capable of detecting an impact load delivered to various parts of a patient's axial skeleton. The sensing means should be capable of detecting the vibrations actually felt by the axial skeleton of the patient at all times. The sensor is attached to the patient and connected, directly or indirectly, to a controller. By way of example, the sensor of the present invention can have the same or similar construction and features as the accelerometer disclosed in the '927 patent of Petrofsky et al., which has already been incorporated herein by reference.

Like the sensor, the controller is not limited to a particular type and can include controllers not yet used in the art. The controller includes an electrical circuit for recording vibrations and for sending a signal to the generating means in order to regulate or modify the vibrations such that the vibrations can be decreased in frequency and/or amplitude. The controller should be capable of measuring and recording the vibrations actually felt by the axial skeleton of the patient at all times. Again, by way of example, the controller of the present invention can have the same or similar construction and features as the control disclosed in the '927 patent of Petrofsky et al. Those skilled in the art will also appreciate that the controller can be electrically connected to the programmable computer such that the computer can record and monitor the vibrations felt by the axial skeleton and also, if desired, regulate and/or modify the vibrations.

The present invention is also directed to a method of treating or preventing spinal osteoporosis which includes the steps of generating vibrations for vibrating a platform upon which a patient sits and transmitting the vibrations to the axial skeleton of the patient. In this embodiment, the generating and transmitting steps of the method are preferably performed substantially simultaneously. Preferably, the generating step of the method of the invention includes generating driving vibrations having a frequency of between about 5 Hertz and about 50 Hertz but frequencies outside this range would be permissible. It is further preferred that the method of the invention moves the axial skeleton along a predetermined path.

The method of the invention can further include the step of moving at least one limb of the patient along a predetermined path. Thus, the method of the present invention can be a modification to a riding a stationery exercise bicycle whereby the bicycle seat vibrates thereby transmitting an impact load to the axial skeleton of a patient. The modification allows retention of all of the benefits of riding a bicycle, including muscle and cardiovascular toning, but also adds an element of impact loading to the axial skeleton of a patient's body. Preferably, the moving step is performed substantially simultaneously with the generating and transmitting steps of the method of the invention.

If desired, the method of the method could further include a step of sensing the vibrations felt by the axial skeleton. Additionally, the method could further include a step of controlling the vibrations felt by the axial skeleton.

While the invention has been described in detail and with reference to specific embodiments thereof, it will be apparent to one of ordinary skill in the art that various changes and modifications can be made without departing from the spirit and scope thereof.

1-17. (canceled)

18. A snowboard support system comprising:
a hooking mechanism;
a webbing having a first end and a second end; and
an outer structure;
wherein the hooking mechanism is attached to the first end of the webbing and the outer structure is attached to the second end of the webbing.

19. A snowboard support system according to claim 18, wherein the hooking mechanism further comprises:
a hook,
wherein the hook comprises;
at least one curved finger; and
an end;
wherein the at least one curved finger has an inner radius, wherein the inner radius conforms to an outer radius of a chair lift bar.

20. A snowboard support system according to claim 19, wherein the hooking mechanism further comprises a bottom end attached to the first end of the webbing.

21. A snowboard support system according to claim 19, wherein the hook comprises:
two curved fingers each having a first end; and
a bar;
wherein the two curved fingers are set equidistant from another and joined at the first ends by the bar which is positioned perpendicular to the first ends.

22. A snowboard support system according to claim 21, wherein the hook further comprises an additional bar attached to the two fingers and has a pull tab attached around the bar thereby allowing the user to pull the hook mechanism away from the outer structure.

23. A snowboard support system according to claim 19, wherein the hooking mechanism further comprises a pull tab attached to the at least one finger thereby allowing the user to deploy and retract the hooking mechanism from the outer structure.

24. A snowboard support system according to claim 19, wherein the hooking mechanism further comprises:
A push button release mechanism female portion having a first end and a second end; and
A push button release mechanism male portion having a first end and a second end;
wherein the push button release mechanism female portion rigidly attaches to the at least one finger thereby allowing the user to release the push button release mechanism male portion that is attached to the webbing.

25. A snowboard support system according to claim 19, wherein the hooking mechanism further comprises the push button release mechanism male portion wherein the first end interlocks with the push button release mechanism female portion and the second end is attached to the webbing and allows adjustment of the length of the webbing.

26. A snowboard support system according to claim 18, wherein the outer structure further comprises:
a common shaft;
wherein the first end of the webbing is adjustably attached to the push button release mechanism male portion and the second end of the webbing is non-adjustably attached to the common shaft.

27. A snowboard support system according to claim 18, wherein the outer structure further comprises
an at least one retractor spring mechanism;
an at least one outer wall;
an at least one bearing assembly;
an at least one guidance collar; and
a common shaft having an at least one end;
wherein the at least one outer wall houses the at least one retractor spring mechanism;
wherein the at least one bearing assembly is inboard the at least one retractor spring mechanism;
wherein the at least one guidance collar is inboard the at least one bearing assembly; and
wherein the at least one retractor mechanism, the at least one bearing assembly and the at least one guidance collar are connected together by the common shaft.

28. A snowboard support system according to claim 27, wherein the at least one retractor spring mechanism further comprises:
an outer diameter; and
an inner diameter;
wherein the outer diameter is attached to the outer structure and the inner diameter is attached to the common shaft.

29. A snowboard support system according to claim 27, wherein the at least one bearing assembly further comprises:
an outer race; and
an inner race
wherein the outer race is stationarily fixed to the outer structure and the inner race is fixed to the common shaft thereby supporting the common shaft and allowing the common shaft to rotate while maintaining alignment.

30. A snowboard support system according to claim 27, wherein the at least one guidance collar is fixed to the common shaft providing a space between the at least one guidance collar thereby allowing the webbing to wrap around the common shaft in a uniform manner.

31. A snowboard support system according to claim 27, wherein the outer structure further comprises:
an exterior wheel having an inner diameter and an outer diameter; and
an at least on finger depression;
wherein the exterior wheel is fixed at its inner diameter to the at least one end the common shaft and including the at least one finger depression located at the outer diameter.

32. A snowboard support system according to claim 18, wherein the outer structure further comprises:
an at least one female depression; and
an at least one bracket;
wherein the at least one female depression is capable of accepting the at least one bracket to secure the outer structure to the snowboard.

33. A snowboard support system according to claim 32, wherein the at least one female depression can be a shape selected from the group comprising; a v-shape, a u-shape, a rectangular shape, or a square shape.

34. A snowboard support system according to claim 18, wherein the outer structure stores the hooking mechanism.

35. A snowboard support system according to claim 27, wherein the outer wall of the outer structure further comprises:
a retention bar;
wherein the retention bar locks the hooking mechanism in place while stored on the outer structure.

36. A snowboard support system according to claim 35, wherein the retention bar further comprises:
a compression spring; and
a pivot pin having and external diameter; a rounded head; and an other end;
wherein the compression spring is located around the external diameter of the pivot pin;
and the pivot pin is located at mid span of the retention bar; and the pivot pin being rigidly attached at the other end to the retention bar with the rounded end passing through the outer structure, and
wherein the rounded head is larger than the external diameter of the pivot pin thereby securing the retention bar to the outer structure.

37. A snowboard support system according to claim 35, wherein the retention bar further comprises:
an at least one outboard end; and
an at least one vertical projection;
wherein the at least one vertical projection is rigidly attached near the at least one outboard end of the retention bar thereby allowing the user to rotate the retention bar.

38. A snowboard support system according to claim 37, wherein the retention bar further comprises:
an at least one rounded edge; and
wherein the outer structure further comprises:
an at least one slight depression; and
an at least one side wall;
wherein the at least one rounded edge allows the retention bar to rotate and frictionally engage into the at least one slight depression located in the at least one side wall of the outer structure.

39. A snowboard support system according to claim 18, wherein the outer structure further comprises:
an at least one drain hole;
an at least one lower wall;
and a base;
wherein the at least one drain hole is located proximal to the lower walls or the base of the outer structure.

40. A snowboard support system according to claim 18, wherein the outer structure further comprises:
a rectangular opening having a rounded lip;
wherein the rectangular opening having the rounded lip prevents the fraying of the webbing during extraction and retraction.

41. A snowboard support system according to claim 18, wherein the outer structure further comprises:
An at least one bearing supported elongated wheel;
an upper opening; and
a lower opening;
wherein the at least one bearing supported elongated wheel is located on the upper and lower openings to prevent fraying of the webbing during extraction and retraction.
